(19) United States
(12) Patent Application Publication
(10) Pub. No.: US 2014/0095237 A1
(43) Pub. Date: Apr. 3, 2014

(54) Organizing and Managing Employee Information for a Manager

(71) Applicants: Stefan Ehrler, Biblis (DE); Rebekka Koehnen, Heidelberg (DE)

(72) Inventors: Stefan Ehrler, Biblis (DE); Rebekka Koehnen, Heidelberg (DE)

(21) Appl. No.: 13/633,516

(22) Filed: Oct. 2, 2012

(51) Int. Cl. G06Q 10/06; G06F 3/048

(52) U.S. Cl. 705/7.15

(57) ABSTRACT

A graphical user interface is generated for a manager of multiple employees, including views for the manager to enter, organize, inspect and be reminded of, information regarding one or more of the employees: a team view that identifies, and presents at least one tag for, each of the employees, a notes view including notes generated, or received, by the manager that have not been assigned to any of the employees, and a task view that presents tasks for the manager to perform, each task having either an employee association or no employee association. A new object associated with one or more employees is created. The manager can select any of the employees before creating a new object and automatically associate the new object with that employee. The manager can enter information in a new object before associating the new object with the one or more of the employees.

### BACKGROUND

Managerial responsibility typically implies that the manager works closely together with his or her direct reports or other people for whom they are responsible. Managers should be aware about the main activities of their people, such as tasks, work, progress, development, training, problems, or other issues, to name just a few examples. A managers usually attends various meetings and discussions with their people, such as individual meetings, development meetings, or reviews. Managers sometime encounter other employees or managers to discuss people-related tasks, development or issues. In addition, managers are usually responsible for people development. In that context the manager is expected to collect a great deal of information.

### SUMMARY

In a first aspect, a computer-implemented method for organizing and managing employee information for a manager includes: generating, using one or more processors, a graphical user interface (GUI) for a person who is a manager of multiple employees, the GUI including views for the manager to enter, organize, inspect and be reminded of, information regarding one or more of the employees, the views including: (i) a team view that identifies, and presents at least one tag for, each of the employees, (ii) a notes view including notes generated, or received, by the manager that have not been assigned to any of the employees, and (iii) a task view that presents tasks for the manager to perform, each task having either an employee association or no employee association. The method includes creating a new object under guidance of the GUI. The method includes assigning either a task type or a note type to the new object. The method includes associating the new object with one or more of the employees. The team view provides for manager selection of any of the employees before creating the new object and automatic association of the new object with that employee upon creation. The notes view and the task view both provide for manager information entry in the new object before associating the new object with the one or more of the employees.

In a second aspect, a computer program product is embodied in a non-transitory computer-readable storage medium and includes instructions that when executed by a processor perform a method for organizing and managing employee information for a manager. The method includes: generating, using one or more processors, a graphical user interface (GUI) for a person who is a manager of multiple employees, the GUI including views for the manager to enter, organize, inspect and be reminded of, information regarding one or more of the employees, the views including: (i) a team view that identifies, and presents at least one tag for, each of the employees, (ii) a notes view including notes generated, or received, by the manager that have not been assigned to any of the employees, and (iii) a task view that presents tasks for the manager to perform, each task having either an employee association or no employee association. The method includes creating a new object under guidance of the GUI. The method includes assigning either a task type or a note type to the new object. The method includes associating the new object with one or more of the employees. The team view provides for manager selection of any of the employees before creating the new object and automatic association of the new object with that employee upon creation. The notes view and the task view both provide for manager information entry in the new object before associating the new object with the one or more of the employees.

In a third aspect, a computer program product is embodied in a non-transitory computer-readable storage medium, the computer program product including instructions that, when executed, generate on a display device a graphical user interface (GUI) for organizing and managing employee information for a person who is a manager of multiple employees. The graphical user interface includes views for the manager to enter, organize, inspect and be reminded of, information regarding one or more of the employees. The views include a team view that identifies, and presents at least one tag for, each of the employees. The views include a notes view including notes generated, or received, by the manager that have not been assigned to any of the employees. The views include a task view that presents tasks for the manager to perform, each task having either an employee association or no employee association. A new object is created under guidance of the GUI, either a task type or a note type is assigned to the new object, and the new object is associated with one or more of the employees. The team view provides for manager selection of any of the employees before creating the new object and automatic association of the new object with that employee upon creation. The notes view and the task view both provide for manager information entry in the new object before associating the new object with the one or more of the employees.

Implementations can include any or all of the following features. The manager selects a first employee in the team view before the new object is created, and the method further includes presenting an employee view in the GUI comprising: information about the first employee; an editor control initiating an editor configured for generating the new object regarding the first employee; one or more tasks for the manager regarding the first employee; and one or more notes regarding the first employee. The manager activates the editor control, and the method further includes generating an editor view in the GUI, the editor view comprising a text field for the manager to enter information regarding the first employee, and a tag field for the manager to assign one or more tags to the new object. The editor view further includes a control for the manager to assign either the task type or the note type to the new object. The team view includes multiple items each representing one of the employees, wherein each item is configured to present, regarding the corresponding employee: an associated document, a kudos counter, a flag counter, and a checkmark counter. The notes view includes one or more unassigned notes generated by the manager, and one or more electronic messages received by the manager. The task view provides for manager selection between a card view where each of multiple tasks is represented by a card, and a list view where each of the multiple tasks is represented by a list item.

Implementations can provide any or all of the following advantages. A better alignment of company goals and individual goals along the activities of the employees can be obtained. An implementation can help a manager gather feedback and e-mails during a period of employee review (e.g., a year), using a mobile device as a central storage device for all information the manager gathers about the employees. An implementation can help a manager capture notes in individual meetings with employees, and tag the notes, for example with performance goals or competencies. An implementation can help a manager get a holistic view of his or her employees, easily access employee data, and/or track their development. An implementation can help a manager define and monitor tasks and next steps for his or her team. An implementation can help a manager review all notes, e-mails, feedback or any other relevant information in a structured way, in order to be prepared for employee meetings and year-end appraisals. An implementation can help a manager track the progress and the development of his or her employees. An implementation can help a manager in managing tasks for all people beyond their direct reports but also be valid for project managers who need to note things such as to-do lists and tasks for other people outside their direct line.

The details of one or more implementations are set forth in the accompanying drawings and the description below. Other features and advantages will be apparent from the description and drawings, and from the claims.

### DESCRIPTION OF DRAWINGS

FIGS. 1A-B show examples of a team view.

FIG. 2 shows an example of an employee view.

FIG. 3 shows an example of an editor view.

FIG. 4 shows an example of a notes view.

FIG. 5 shows an example of an employee scorecard.

FIG. 6A shows an example of an employee view with a tag cloud.

FIG. 6B shows an example of an employee view with a bar chart.

FIG. 7A shows an example of a task view with task cards.

FIG. 7B shows an example of a task view with a list of tasks.

FIG. 8 schematically shows an example of a mobile device having a team view, notes view, employee view and editor views.

FIG. 9 is a block diagram of a computing system that can be used in connection with computer-implemented methods described in this document.

Like reference symbols in the various drawings indicate like elements.

### DETAILED DESCRIPTION

This document describes examples of systems and techniques for organizing and managing employee information. Certain implementations can provide a manager the ability, throughout an entire review period, to capture notes that relate to performance goals or competencies of the employees for whom the manager is responsible. This can for example be useful if the company practices the management technique commonly referred to as Management by Objectives. Particularly, the manager can use one or more implementations to apply specific tags to notes, e-mails, or any other type of information regarding his or her employees and thereby gain an overview, in a sense like an “employee magazine,” of the achievements by each individual employee.

For example, in interim reviews, personal talks, or year-end reviews the manager can use such tagged information in order to provide valuable and concrete feedback to the employees, as opposed to, say, merely giving generic feedback which may not be particularly helpful.

One of the main tasks of a manager is to rate his or her employees on their performance and development. Employee goals are often defined by breaking down a larger goal, such as a company goal, into smaller goals. However, it may be difficult for a manager to remember achievements by the employee that took place months ago. Some implementations therefore facilitate this process by capturing, essentially anytime and anywhere, information relating to employee goals, development and competencies. The manager can quickly assign and tag such captured information with the goal or goals that apply to the individual employee.

In some implementations, a manager who is assigned to supervise a number of employees can use a mobile device (such as a smartphone or a tablet) that presents views where the manager enters, organizes, inspects and is reminded of, information regarding one or more of the employees. Such views can include, but are not limited to, a team view, a notes view, a task view, an employee view, and/or an editor view. In some implementations, the manager can choose between an employee-centric way and a information-centric way when entering information. For example, the manager can first select the relevant employee and thereafter specify what type of object is being created (e.g., a note or a task), or the manager can first generate an object of the correct type and enter the relevant information (perhaps while the information is fresh in the manager's memory) and the manager can later associate the created note or task with the employee.

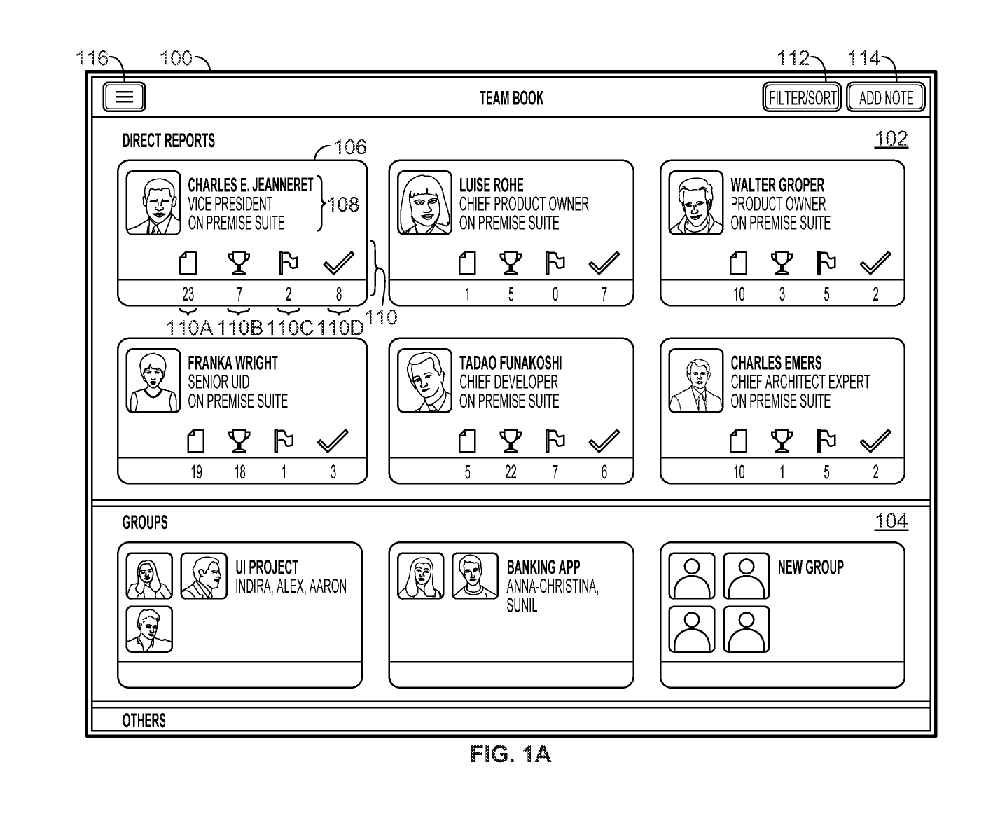

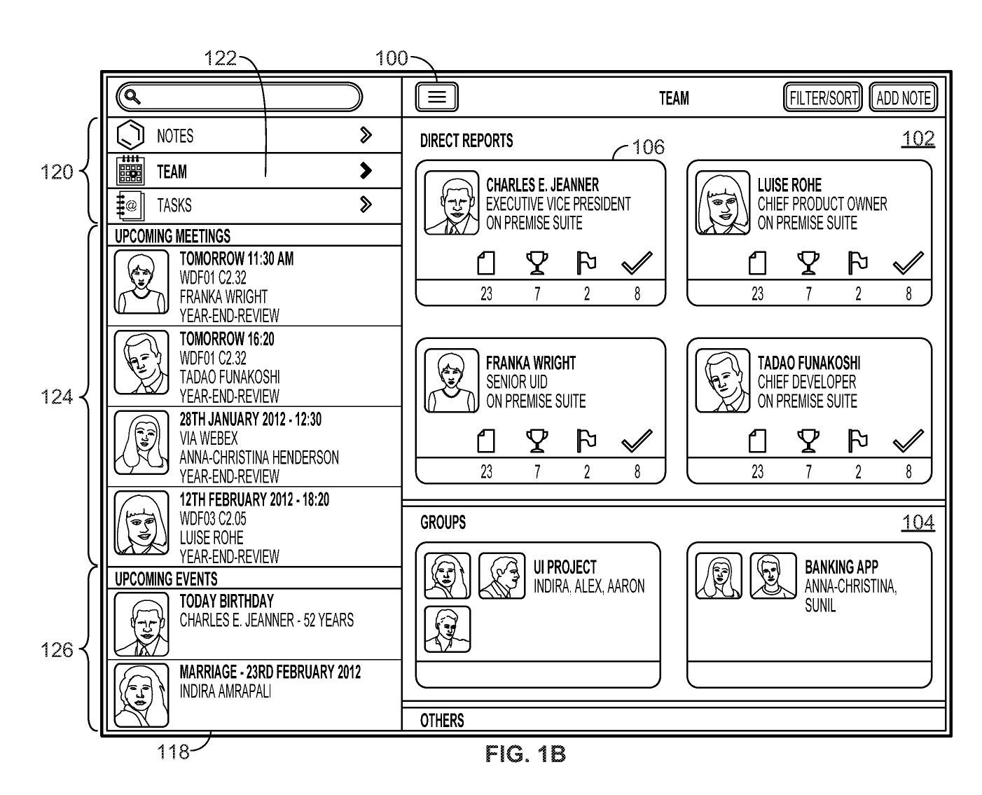

FIGS. 1A-B show examples of a team view 100. The team view 100 identifies, and presents at least one tag for, each of the employees for a manager. The team area can be presented on a mobile device for use by the manager in organizing information regarding supervised employees. The team view includes a direct reports area 102 and a groups area 104. For example, the area 102 identifies the persons who directly report to the manager who is using the team view, and the area 104 identifies groups that the manager is monitoring for one or more reasons.

The direct reports area 102 here includes a number of items 106, each representing one of those employees who directly report to the manager. Each of the items 106 includes an employee information area 108, for example listing the employee's name, position, and the name of the employee's team. The item also includes a tags area 110 indicating tags that have been assigned to that particular employee. For example, the area here indicates an associated document 110A representing attached documents relevant to the employee, a kudos counter 110B representing praise given to the employee, a flag counter 110C representing issues or concerns raised about the employee, and a checkmark counter 110D representing specific goals that have been assigned to this employee, and the performance with regard to such goals.

A filter/sort control 112 allows the manager to filter and/or sort the items 106. For example, the manager can choose to present only those employees who have pending concerns or issues (e.g., indicated by the flags tag 110C), or those employees whose yearly review sessions are coming up.

An add note control 114 allows the manager to create one or more notes or other electronic objects. Examples of this will be described below.

An expand/collapse control 116 can be used to expand an area 118 (FIG. 1B) that presents additional information relevant to the manager. In the area 118, a navigation area 120 provides navigation to respective notes, team or tasks views. Currently, a team control 122 is selected, corresponding to presentation of the direct reports area 102 and the groups area 104.

The area 118 includes a meetings area 124 that presents reminders for one or more meetings that have been scheduled for the manager. For example, the meeting reminder can indicate what employee(s) the manager is meeting with and can allow the manager to navigate to corresponding information about the employee. Similarly, an events area 126 presents reminders regarding one or more upcoming events.

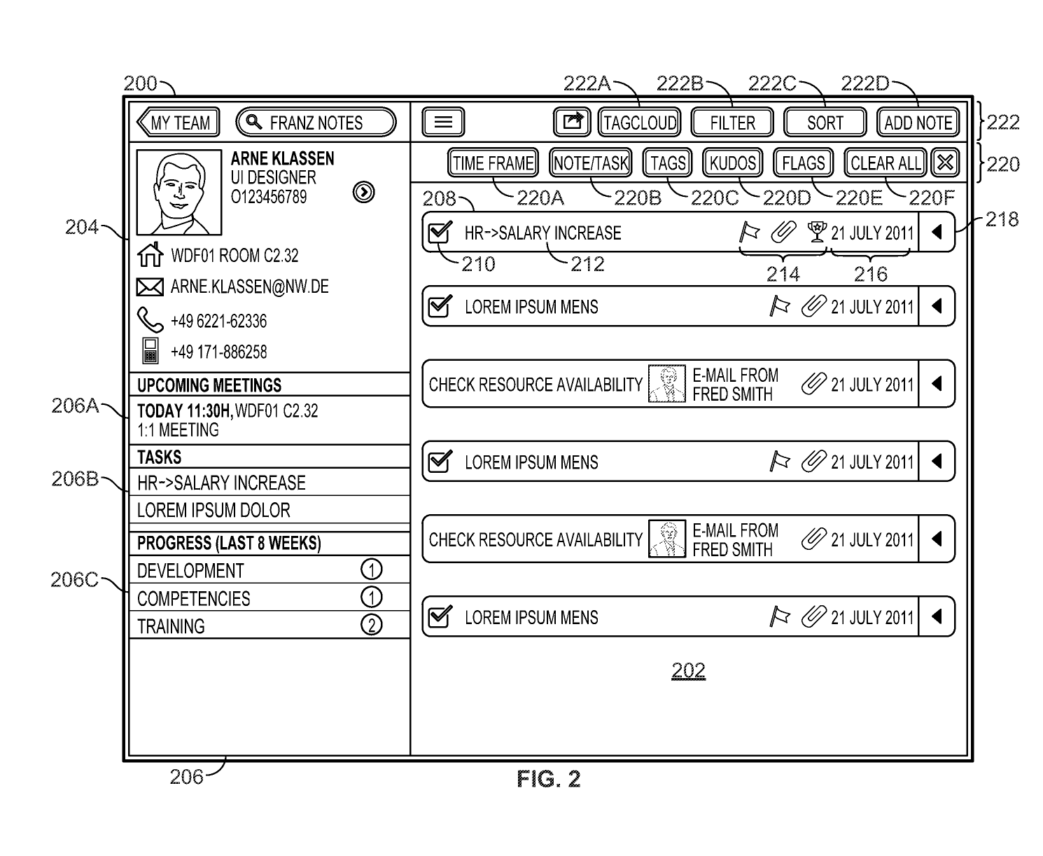

The manager can select any of the items 106 to navigate to a view for that particular employee. In some implementations, the team view provides for manager selection of any of the employees before creating a new object and automatic association of the new object with that employee upon creation. FIG. 2 shows an example of an employee view 200. The employee view includes a notes and tasks area 202, an employee information area 204 and a navigation area 206. The notes and tasks area includes items 208, each of which represents a note or a task and includes one or more of: an indicator 210 (e.g., to signal that this is an individual goal set for the employee), a title 212 (e.g., to indicate what the note is about), a tags area 214 (e.g., to indicate whether the note is about a concern, an attached document, and/or kudos for the employee), a date 216 for when the note was created (or last modified), and an expand/collapse control 218 to present the note in its entirety (or only a header summary).

A first toolbar 220 allows the manager to perform one or more operations. For example, such operations can include, but are not limited to: sorting or filtering the notes and tasks by timeframe (tool 220A), sorting or filtering notes from tasks, or vice versa (tool 220B), sorting or filtering by tags (tool 220C), sorting or filtering kudos (tool 220D), sorting or filtering by flags (tool 220E), or clearing all notes and tasks (tool 220F).

A second toolbar 222 also allows the manager to perform one or more operations. For example, such operations can include, but are not limited to: viewing a tag cloud for the employee (tool 222A), filtering information about the employee (tool 222B), sorting information about the employee (tool 222C), and adding a note regarding the employee (tool 222D). For example, the tool 222D can be used to access an editor configured for generating a new object regarding the first employee, such as a new note or task. That is, the tool 222D is one example of a tool for creating a new object.

In the navigation area 206, a meetings area 206A indicates when the manager has the next meeting with this employee; a tasks area 206B highlights the tasks that the manager should perform regarding this employee (e.g., contact human resources (HR) regarding a possible salary increase for the employee), and a progress area indicates fulfillment of one of more goals set for the employee, for example regarding the employee's professional development, competency increase or training attendance.

Assume now that the manager wishes to enter a new note or task regarding this employee. For example, the manager may have opened the employee view 100 because of an upcoming or ongoing meeting with the employee, and after the meeting the manager needs to make some notes regarding the meeting. Because the manager has already navigated to the employee view 100 for that particular employee before creating any new object (e.g., note or task), this can be viewed as an employee-centric approach. For example, the manager can activate the add note tool 222D to access an editor.

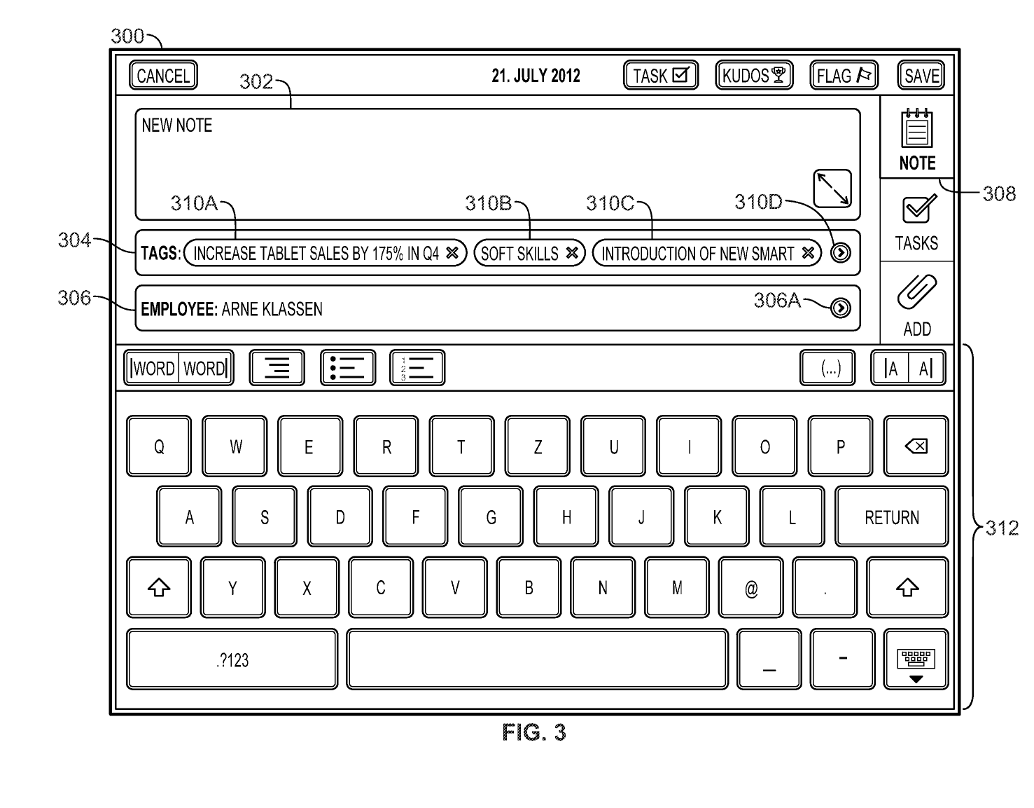

FIG. 3 shows an example of an editor view 300. The editor view includes a text field 302 for the manager to enter information regarding the employee, a tag field 304 for the manager to assign one or more tags to the new object that is being created (e.g., a note), and an employee field 306 for specifying the relevant employee. In this example, a tab 308 indicates that a note is being generated, as opposed to, say, generating a new task or associating an attached document with the employee. That is, the tab 308 is an example of a tool for assigning a type, such as a task type or a note type, to the new object.

The tag field 304 here includes a tag 310A that sets a goal for the employee (e.g., to increase tablet sales by 175% in Q4), a tag 310B that indicates a qualification that the employee has (e.g., soft skills), and a tag 310C that indicates a project where the employee is working (e.g., the introduction of a new smartphone application). The manager can delete any of the tags 310A-C, and/or add one or more other tags using a control 310D.

In some implementations, the manager can define his or her own tags. For example, the manager may wish to create a special tag for employees who have performed extraordinarily well, to give them a special bonus at the end of the fiscal year.

A keyboard area 310 can be presented, for example when the editor view is displayed on a touchscreen device (e.g., a smartphone or a tablet).

In the employee field 306, a control 306A allows the manager to assign one or more other employees to the same note. For example, the manager may have created the note to acknowledge this employee's work on a particular project, and may then decide to also include another employee who also worked on the same project.

That is, after creating the new object using the editor view 300, the new object can be presented in one or more other views. For example, in the employee view 200 (FIG. 2), the new object can be presented in the notes and tasks area 202 and/or in the tasks area 206B.

The above example involved an employee-centric approach for the manager to generate, store and organize information relating to a particular employee. Another approach can be considered information-centric. With reference again briefly to FIG. 1B, assume that the manager selects another control in the navigation area 120. For example, the manager selects a notes control to directly begin entering a new note.

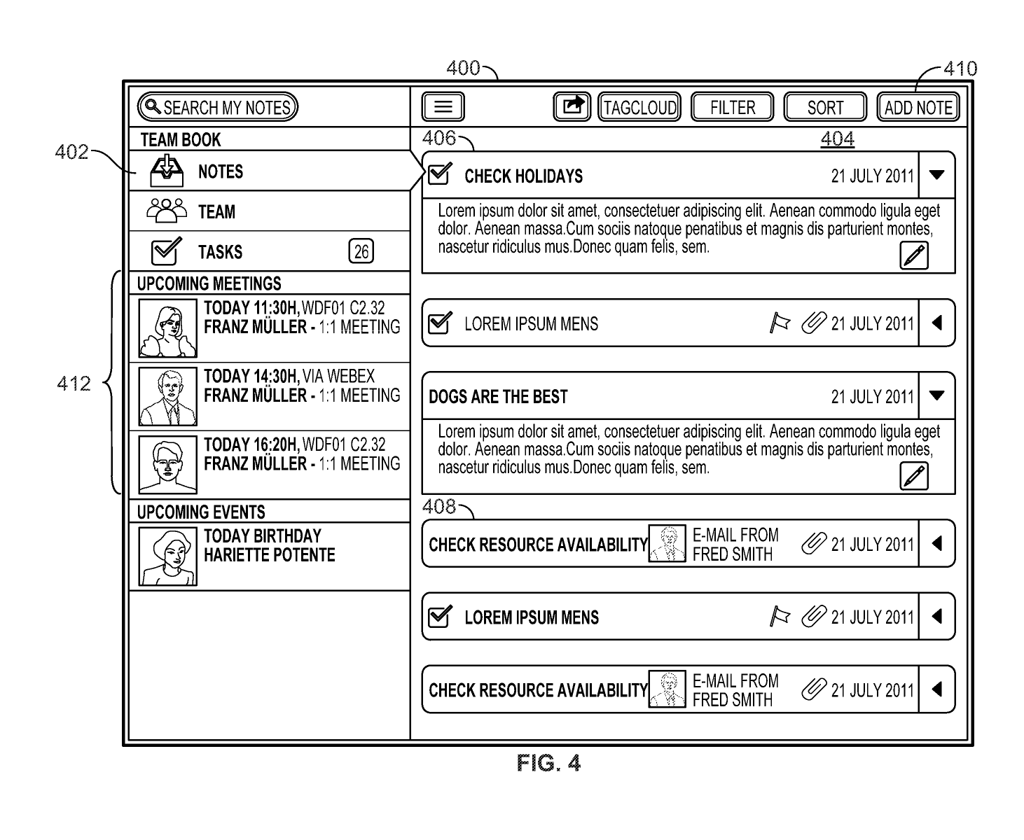

FIG. 4 shows an example of a notes view 400. In some implementations, the notes view is presented upon the manager selecting a notes control 402. The notes view presents notes generated, or received, by the manager that have not been assigned to any of the employees. Here, the notes view includes a notes area 404 that contains one or more unassigned notes 406. For example, the notes 406 may have been generated by the manager at an earlier time and have not yet been associated with a particular employee. The notes area also includes one or more unassigned electronic messages 408. For example, the electronic message can be an email that was received by the manager; if the message pertains to a particular employee, the manager may wish to assign the message to that employee.

The notes view 400 includes an add note control 410 for generating one or more new objects. In some implementations, when the manager activates the add note control the editor view 300 (FIG. 3) can be presented. The notes view can provide for manager information entry in the new object before associating the new object with the one or more of the employees. For example, this can allow the manager to go directly from viewing existing notes (e.g., in the notes area 404) to typing in a new note that has not yet been associated with a particular employee. A meetings and events area 412 can identify one or more employees with which the manager has a meeting scheduled, and/or who is involved in an upcoming event.

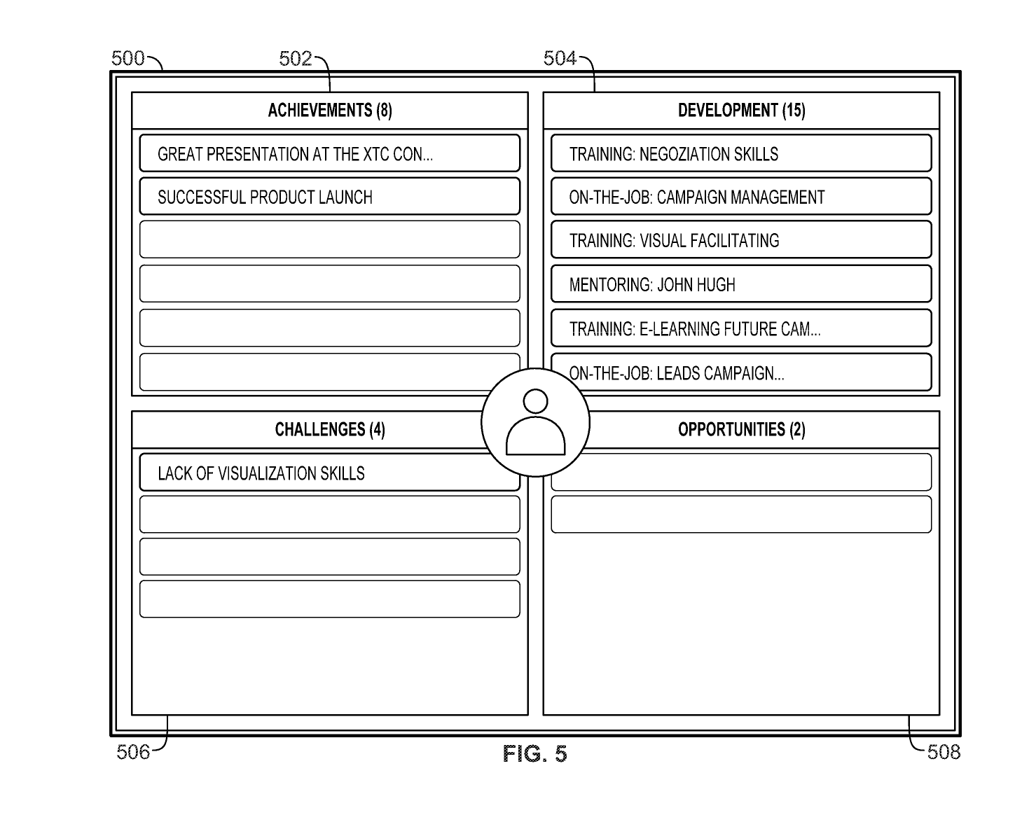

FIG. 5 shows an example of an employee scorecard 500. The scorecard can present a collection of tags that have been assigned to a particular employee. In some implementations, the employee scorecard can give the manager an overview of the characteristics for that employee, based on the notes, tasks, associated documents and/or other information that the manager has entered and/or assigned to that employee. Here, the employee scorecard includes an achievements area 502 (e.g., that includes positive feedback for the employee), a development area 504 (e.g., that includes suggested, planned or completed development goal for the employee), a challenges area 506 (e.g., that includes negative feedback for the employee) and an opportunities area 508 (e.g., that includes opportunities for the employee individually, or where the employee is one of those involved).

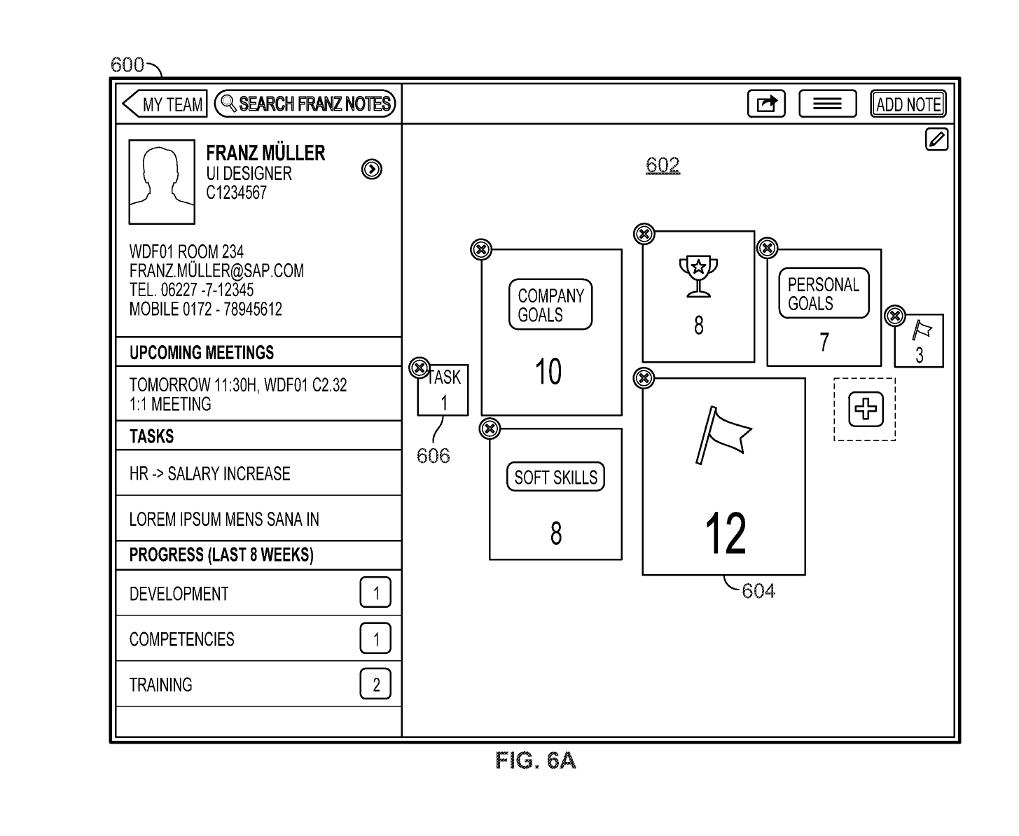

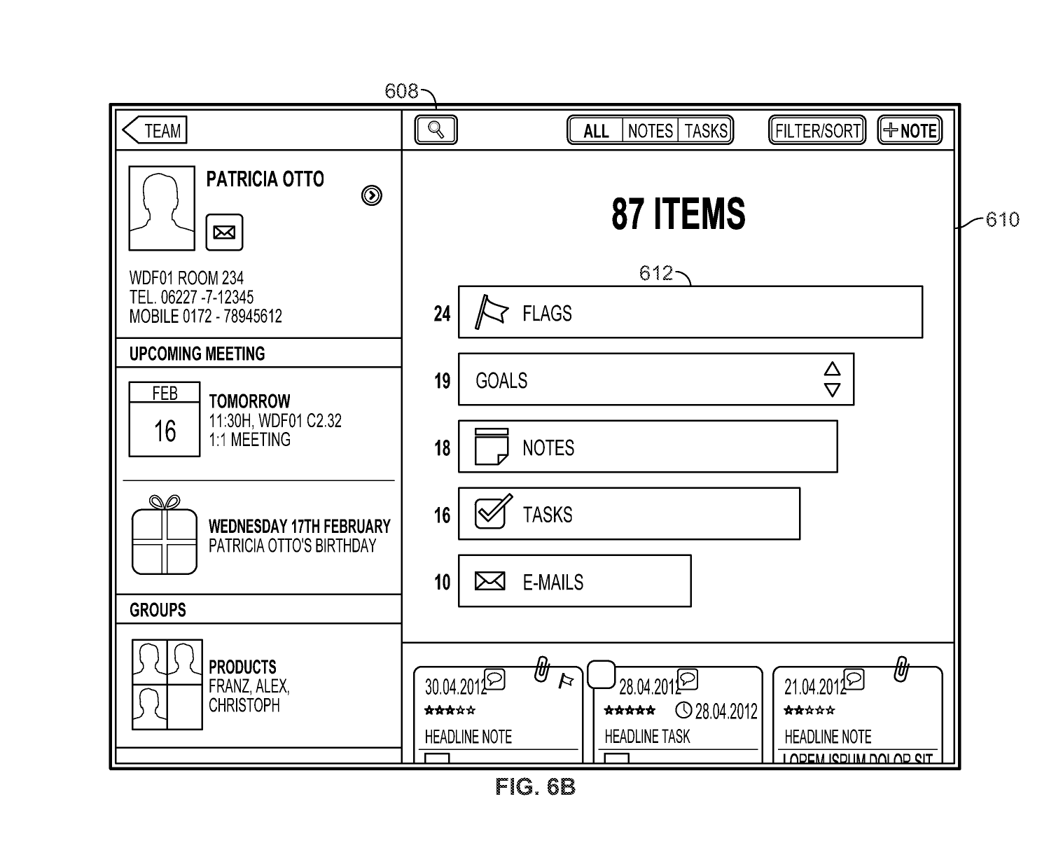

Employee information can be presented in different ways, for example by way of a toggle switch or other control that lets the manager choose any of multiple modes of presentation. FIG. 6A shows an example of an employee view 600 with a tag cloud 602. With reference again briefly to FIG. 2, the tag cloud can be presented when the manager activates the tool 222A. In some implementations, the tag cloud presents one or more tags organized according to category and with an indication of volume, extent, significance or size. For example, a flag box 604 indicates that twelve flags of a certain kind have been generated for this employee, whereas a substantially smaller task box 606 indicates that only one task is pending for this employee. The tags can be assigned by the manager in any of various situations, for example using the tag field 304 (FIG. 3).

FIG. 6B shows an example of an employee view 608 with a bar chart 610. The bar chart includes bars 612 each of which can correspond to a type of tag and indicate, graphically and/or numerically, the number of tags of that type.

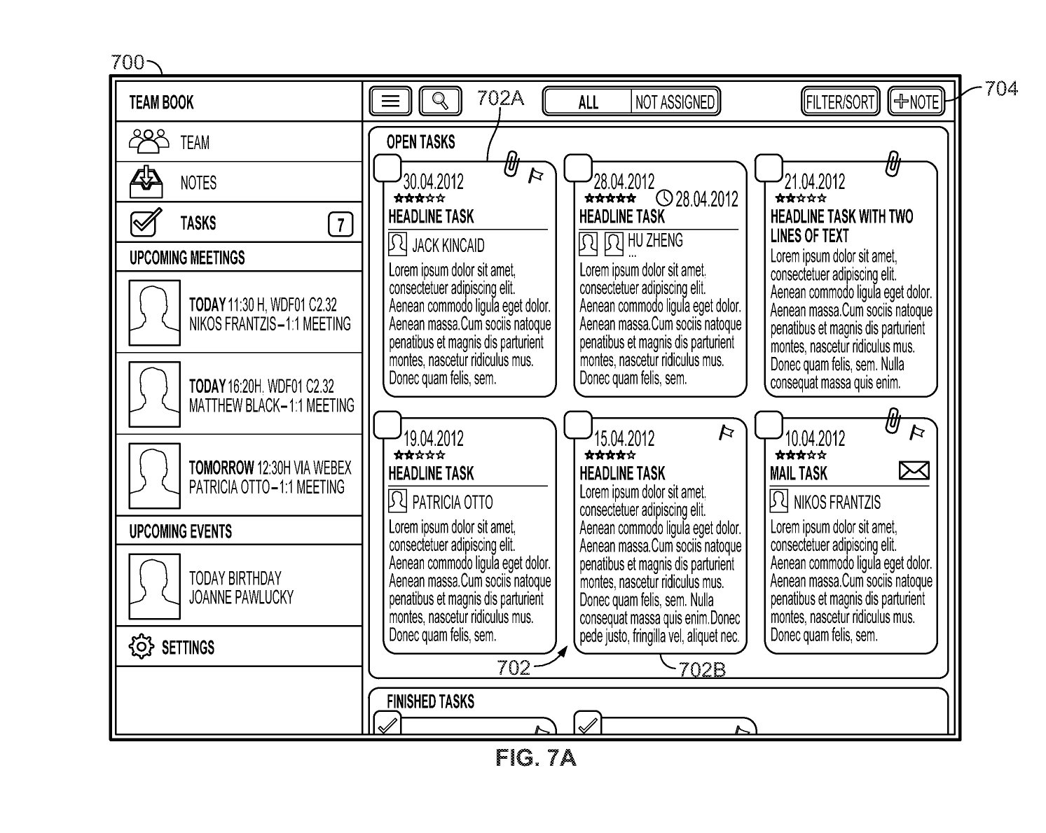

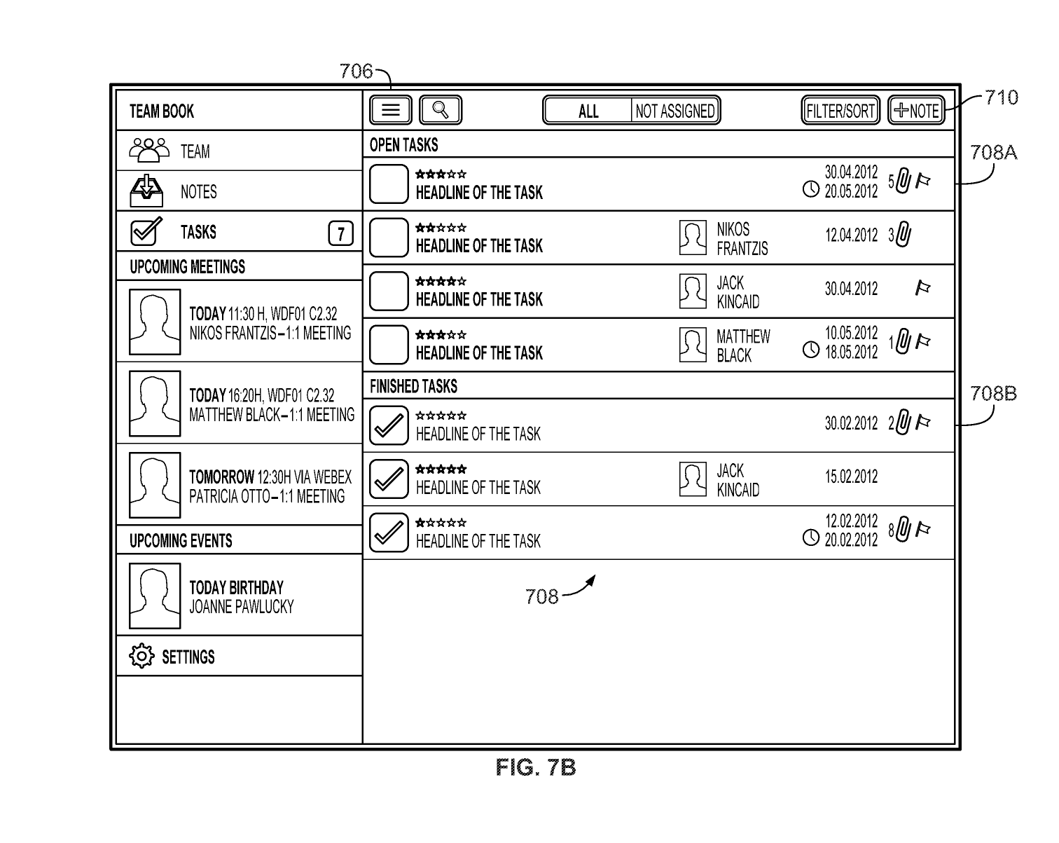

Task information can be presented in different ways, for example by way of a toggle switch or other control that lets the manager choose any of multiple modes of presentation. FIG. 7A shows an example of a task view 700 with task cards 702. The task view presents tasks for the manager to perform, each task having either an employee association or no employee association. Here, for example, a task card 702A is assigned to employee Jack Kincaid whereas task card 702B has not been assigned to an employee. Each of the task cards corresponds to a particular task and can indicate one or more tags and/or attached documents regarding the task. The task view includes a control 704 for creating a new object, such as a note or task. For example, activating this control can initiate the editor view 300 (FIG. 3). That is, the task view can provide for manager information entry in a new object before associating the new object with an employee.

FIG. 7B shows an example of a task view 706 with a list of tasks 708. Each task is represented by an item in a list. The list can be sorted in one or more different ways, such as to separate open tasks from finished tasks. For example, a task 708A is here classified as open whereas another task 708B is finished. Each task can indicate one or more tags and/or attached documents regarding the task.

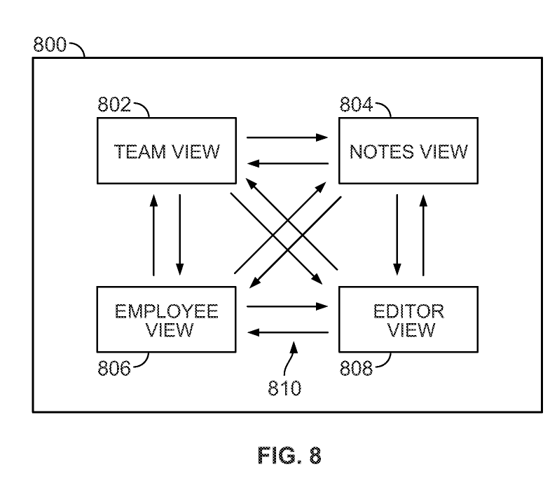

FIG. 8 schematically shows an example of a mobile device 800 having a team view 802, notes view 804, employee view 806 and editor view 808. Arrows 810 schematically illustrate that the manager can navigate between the various views in multiple ways. For example, from the team view the manager can select an employee and therefore navigate to the employee view, where the manager can choose to create a new object (e.g., a note or task) regarding that employee, which takes the manager to the editor view. This can be considered an employee-centric object creation. Once created, the new object can appear in the employee view (e.g., view 200 in FIG. 2) for that employee.

As another example, from the notes view the manager can choose to create a new object (e.g., a note or task), which takes the manager to the editor view, but at this time the new object is not yet assigned to any employee. Rather, once created, the new object can remain in the manager's notes view (e.g., the view 400 in FIG. 4). If the manager chooses to assign the created object to an employee (e.g., using the field 306 in FIG. 3), the object can thereafter be removed from the notes view and instead appear in the employee view for that employee.

Some of the arrows 810 run cross-wise, such as from the team view 802 directly to the editor view 808. For example, this indicates that the team view can have a control for directly accessing the editor (e.g., the control 114 in FIG. 1). As another example, one of the arrows runs from the notes view 804 directly to the employee view 806. For example, this indicates that the notes view can provide direct access to an employee view (e.g., in the message and events area 412 of FIG. 4).

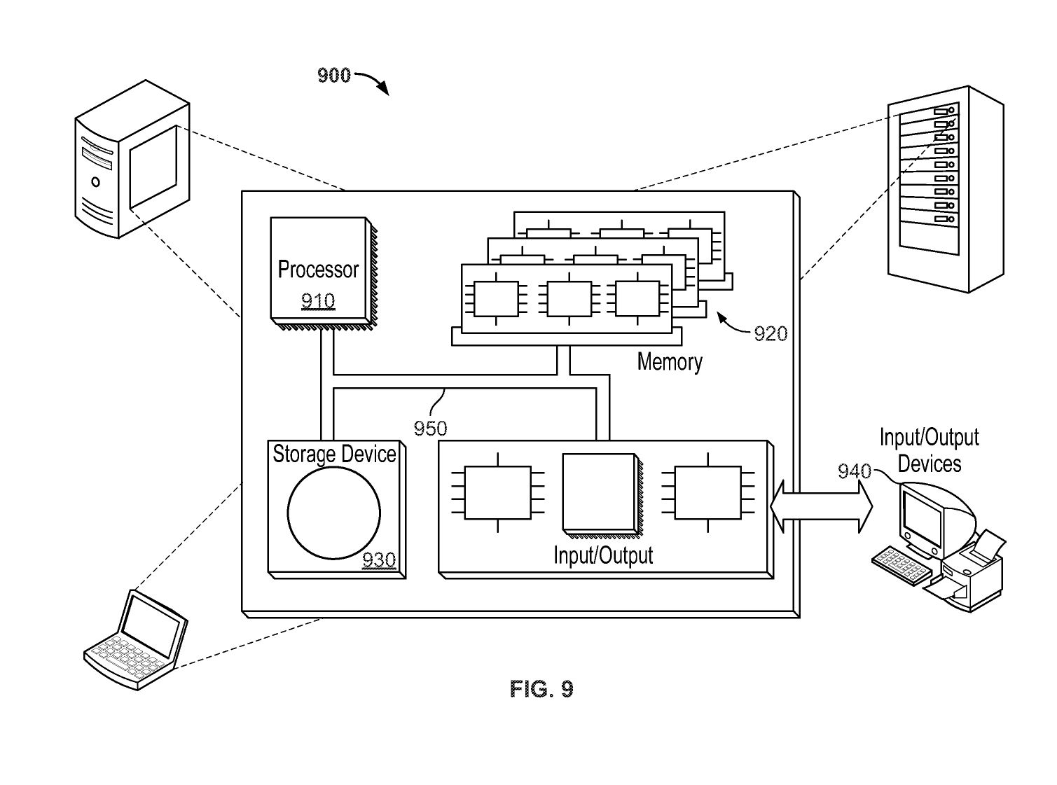

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. The memory 920 is a volatile memory unit in some implementations and is a non-volatile memory unit in other implementations.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for organizing and managing employee information for a manager, the method comprising:
generating, using one or more processors, a graphical user interface (GUI) for a person who is a manager of multiple employees, the GUI including views for the manager to enter, organize, inspect and be reminded of, information regarding one or more of the employees, the views including: (i) a team view that identifies, and presents at least one tag for, each of the employees, (ii) a notes view including notes generated, or received, by the manager that have not been assigned to any of the employees, and (iii) a task view that presents tasks for the manager to perform, each task having either an employee association or no employee association;
creating a new object under guidance of the GUI;
assigning either a task type or a note type to the new object; and
associating the new object with one or more of the employees;
wherein the team view provides for manager selection of any of the employees before creating the new object and automatic association of the new object with that employee upon creation; and
wherein the notes view and the task view both provide for manager information entry in the new object before associating the new object with the one or more of the employees.

2. The computer-implemented method of claim 1, wherein the manager selects a first employee in the team view before the new object is created, the method further comprising presenting an employee view in the GUI comprising:
information about the first employee;
an editor control initiating an editor configured for generating the new object regarding the first employee;
one or more tasks for the manager regarding the first employee; and
one or more notes regarding the first employee.

3. The computer-implemented method of claim 2, wherein the manager activates the editor control, the method further comprising generating an editor view in the GUI, the editor view comprising a text field for the manager to enter information regarding the first employee, and a tag field for the manager to assign one or more tags to the new object.

4. The computer-implemented method of claim 3, wherein the editor view further comprises a control for the manager to assign either the task type or the note type to the new object.

5. The computer-implemented method of claim 1, wherein the team view comprises multiple items each representing one of the employees, wherein each item is configured to present, regarding the corresponding employee: an associated document, a kudos counter, a flag counter, and a checkmark counter.

6. The computer-implemented method of claim 1, wherein the notes view comprises one or more unassigned notes generated by the manager, and one or more electronic messages received by the manager.

7. The computer-implemented method of claim 1, wherein the task view provides for manager selection between a card view where each of multiple tasks is represented by a card, and a list view where each of the multiple tasks is represented by a list item.

8. A computer program product embodied in a non-transitory computer-readable storage medium and comprising instructions that when executed by a processor perform a method for organizing and managing employee information for a manager, the method comprising:
generating, using one or more processors, a graphical user interface (GUI) for a person who is a manager of multiple employees, the GUI including views for the manager to enter, organize, inspect and be reminded of, information regarding one or more of the employees, the views including: (i) a team view that identifies, and presents at least one tag for, each of the employees, (ii) a notes view including notes generated, or received, by the manager that have not been assigned to any of the employees, and (iii) a task view that presents tasks for the manager to perform, each task having either an employee association or no employee association;
creating a new object under guidance of the GUI;
assigning either a task type or a note type to the new object; and
associating the new object with one or more of the employees;
wherein the team view provides for manager selection of any of the employees before creating the new object and automatic association of the new object with that employee upon creation; and
wherein the notes view and the task view both provide for manager information entry in the new object before associating the new object with the one or more of the employees.

9. The computer program product of claim 8, wherein the manager selects a first employee in the team view before the new object is created, the method further comprising presenting an employee view in the GUI comprising:
information about the first employee;
an editor control initiating an editor configured for generating the new object regarding the first employee;
one or more tasks for the manager regarding the first employee; and
one or more notes regarding the first employee.

10. The computer program product of claim 9, wherein the manager activates the editor control, the method further comprising generating an editor view in the GUI, the editor view comprising a text field for the manager to enter information regarding the first employee, and a tag field for the manager to assign one or more tags to the new object.

11. The computer program product of claim 10, wherein the editor view further comprises a control for the manager to assign either the task type or the note type to the new object.

12. The computer program product of claim 8, wherein the team view comprises multiple items each representing one of the employees, wherein each item is configured to present, regarding the corresponding employee: an associated document, a kudos counter, a flag counter, and a checkmark counter.

13. The computer program product of claim 8, wherein the task view provides for manager selection between a card view where each of multiple tasks is represented by a card, and a list view where each of the multiple tasks is represented by a list item.

14. A computer program product embodied in a non-transitory computer-readable storage medium, the computer program product including instructions that, when executed, generate on a display device a graphical user interface (GUI) for organizing and managing employee information for a person who is a manager of multiple employees, the graphical user interface including views for the manager to enter, organize, inspect and be reminded of, information regarding one or more of the employees, the views comprising:
a team view that identifies, and presents at least one tag for, each of the employees;
a notes view including notes generated, or received, by the manager that have not been assigned to any of the employees; and
a task view that presents tasks for the manager to perform, each task having either an employee association or no employee association;
wherein a new object is created under guidance of the GUI, either a task type or a note type is assigned to the new object, and the new object is associated with one or more of the employees;
wherein the team view provides for manager selection of any of the employees before creating the new object and automatic association of the new object with that employee upon creation; and
wherein the notes view and the task view both provide for manager information entry in the new object before associating the new object with the one or more of the employees.

15. The computer program product of claim 14, wherein the manager selects a first employee in the team view before the new object is created, the method further comprising presenting an employee view in the GUI comprising:
information about the first employee;
an editor control initiating an editor configured for generating the new object regarding the first employee;
one or more tasks for the manager regarding the first employee; and
one or more notes regarding the first employee.

16. The computer program product of claim 15, wherein the manager activates the editor control, the method further comprising generating an editor view in the GUI, the editor view comprising a text field for the manager to enter information regarding the first employee, and a tag field for the manager to assign one or more tags to the new object.

17. The computer program product of claim 16, wherein the editor view further comprises a control for the manager to assign either the task type or the note type to the new object.

18. The computer program product of claim 15, wherein the team view comprises multiple items each representing one of the employees, wherein each item is configured to present, regarding the corresponding employee: an associated document, a kudos counter, a flag counter, and a checkmark counter.

19. The computer program product of claim 15, wherein the notes view comprises one or more unassigned notes generated by the manager, and one or more electronic messages received by the manager.

20. The computer program product of claim 15, wherein the task view provides for manager selection between a card view where each of multiple tasks is represented by a card, and a list view where each of the multiple tasks is represented by a list item.
